(19) United States
(12) Patent Application Publication
(10) Pub. No.: US 2025/0066567 A1
(43) Pub. Date: Feb. 27, 2025

(54) RADIATIVE COOLING METAMATERIAL COMPOSITION AND METAMATERIAL FILM PREPARED FROM SAME

(71) Applicant: IUCF-HYU (INDUSTRY-UNIVERSITY COOPERATION FOUNDATION HANYANG UNIVERSITY), Seoul (KR)

(72) Inventors: Dong Rip KIM, Seoul (KR); Kang Won LEE, Seoul (KR); Jonghun YI, Busan (KR); Yale JEON, Incheon (KR)

(73) Assignee: IUCF-HYU (INDUSTRY-UNIVERSITY COOPERATION FOUNDATION HANYANG UNIVERSITY), Seoul (KR)

(21) Appl. No.: 18/726,474

(22) PCT Filed: Dec. 30, 2022
(86) PCT No.: PCT/KR2022/021711

§ 371 Date: Jul. 3, 2024

(30) Foreign Application Priority Data
Jan. 5, 2022 (KR) 10-2022-0001322
Nov. 30, 2022 (KR) 10-2022-0164491

(51) Int. Cl. C08J 5/18; C08K 3/04; C08K 3/22; C08K 3/36; C08K 5/00; C08K 9/12

(52) U.S. Cl. CPC C08J 5/18; C08K 3/042; C08K 3/22; C08K 3/36; C08K 5/0041; C08K 9/12; C08K 2003/2241

(57) ABSTRACT

The present invention relates to a metamaterial composition having excellent radiative cooling characteristics and a film prepared from same. The metamaterial of the present invention comprises a base material, aerogel particles and optical control agent, and thus can exhibit high visible light transmittance and excellent infrared emissivity even with a thin thickness. Therefore, the metamaterial of the present invention can be used as a radiative cooling film requiring transparency, and can be usefully applied to, especially, a cover window for a display.

### TECHNICAL FIELD

The present disclosure relates to a metamaterial composition having radiative cooling characteristics and to a metamaterial film prepared by using the same, and more particularly, to a metamaterial composition having high visible light transmittance and excellent radiative cooling characteristics even with a thin thickness, and to a metamaterial film prepared by using the same.

### BACKGROUND ART

Radiative cooling is a phenomenon that occurs when an object radiates heat in the form of infrared radiation. When the amount of radiation emitted from an object is more than the energy absorbed, radiative cooling phenomenon occurs and the temperature of the object decreases, and radiative cooling technologies that can utilize this characteristic to realize a cooling effect without external energy input are gaining attention.

In particular, the atmosphere does not absorb electromagnetic waves in a wavelength range of 8 to 13 μm, called an atmospheric window region, so the electromagnetic waves in that region are characterized by being emitted outside from the Earth. Therefore, research is being conducted to increase the cooling effect by enhancing the radiation from the atmospheric window region.

For example, Korean Patent Publication No. 10-2020-0061074 discloses a technology for enhancing radiative cooling performance by forming a lattice patterning structure in a PDMS thin film to have a high emissivity in the atmospheric window region to enhance a radiative cooling effect. In addition, Korean Patent No. 10-2036071 relates to a multi-layer radiative cooling structure that is attached to a cooling object to reduce a temperature of the cooling object, and discloses a radiative cooling structure including a dielectric layer and a metal thin film layer that absorb and radiate mid-infrared radiation.

As such, when radiative cooling materials are used, it allows objects to efficiently emit infrared radiation, providing a simple cooling effect without consuming electricity. For example, optoelectronic devices generate heat during operation, which reduces their efficiency. However, the efficiency of the device may be improved by applying a radiative cooling material in the form of a film to dissipate the heat.

However, general radiative cooling materials have the characteristics of reflecting most of the incident light, resulting in reflection of visible light and low transparency. As a result, radiative cooling materials have had limitations that make them unsuitable for use as cover windows for display devices such as mobile phones and TVs. Therefore, there is a need to develop a radiative cooling film material that may be used for displays, with excellent heat dissipation and high visible light transmittance.

In addition, in order to make the display thinner and lighter, it is necessary to meet all of the above characteristics even with a thin thickness. Recently, not only general flat panel displays but also flexible displays that can be bent have been commercialized. Thus, in addition to optical properties, mechanical properties such as tensile strength are also important factors in radiative cooling films for displays.

In this situation, the inventors of the present disclosure have completed the present disclosure by founding that the use of aerogel particles and an optical modulator in combination allows for the preparation of radiative colling metamaterials with excellent mechanical properties while improving emissivity in the atmospheric window region, even with a thin thickness, without impairing visible light transmission.

### DISCLOSURE

### Technical Problem

Object of the present disclosure is to provide a composition capable of preparing metamaterials with excellent transparency and radiative cooling performance.

Another object of the present disclosure is to provide a radiative cooling metamaterial film prepared by using the metamaterial composition.

Still another object of the present disclosure is to provide a method for preparing a metamaterial film using the metamaterial composition.

### Technical Solution

The present disclosure provides a metamaterial composition comprising a base resin, aerogel particles, and an optical modulator impregnated into the aerogel particles.

In the present disclosure, the optical modulator may be an organic compound having a difference in refractive index of 0.05 or less from the base resin.

In the present disclosure, the base resin may have a refractive index of 1.2 to 1.8.

In the present disclosure, the base resin may be one or more selected from the group consisting of polyimide (PI), colorless polyimide (CPI), polydimethylsiloxane (PDMS), perfluoropolyether (PFPE), polyurethane (PU), polyethylene (PE), polypropylene (PP), polycarbonate (PC), polystyrene (PS), polyester, and polyamide.

In the present disclosure, the aerogel particles may be one or more selected from the group consisting of silica (SiO₂) aerogels, titania (TiO₂) aerogels, carbon aerogels, and graphene aerogels.

In the present disclosure, the aerogel particles may be comprised in an amount of 1 to 10 wt %, based on the total weight of the metamaterial composition.

In the present disclosure, a difference in dielectric constant between the aerogel particles and the base resin may be 2 or less.

In the present disclosure, the content of the optical modulator may be from 2 to 30 wt %, based on the total weight of the metamaterial composition.

In the present disclosure, the optical modulator may be one or more selected from the group consisting of polymethyl methacrylate (PMMA), diethylenetriamine (DETA), N-methyl-2-pyrrolidone (NMP), polyvinyl methyl ether, poly(3-methoxypropyl acrylate), poly(1-octadecene), poly(2-ethoxyethyl acrylate), polyisopropyl acrylate, poly(1-decene), polypropylene, polylauryl methacrylate, polyvinyl sec-butyl ether, poly(n-butyl acrylate), polydodecyl methacrylate, polyethylene succinate, polytetradecyl methacrylate, polyhexadecyl methacrylate, cellulose acetate butyrate, cellulose acetate, polyvinyl formate, ethylene/vinyl acetate copolymer-40% vinyl acetate, poly(2-fluoroethyl methacrylate), polyoctyl methyl silane, ethylcellulose, polymethyl acrylate, polydicyanopropyl siloxane, polyoxymethylene, poly(sec-butyl methacrylate), poly(dimethylsiloxane-co-α-methyl styrene), poly(n-hexyl methacrylate), ethylene/vinyl acetate copolymer-33% vinyl acetate, poly(n-butyl methacrylate), poly(ethylidene dimethacrylate), poly(2-ethoxyethyl methacrylate), poly(n-propyl methacrylate), polyethylene malate, ethylene/vinyl acetate copolymer-28% vinyl acetate, polyethyl methacrylate, polyvinyl butyral, poly(3,3,5-trimethylcyclohexyl methacrylate), poly(2-nitro-2-methylpropyl methacrylate), poly(dimethylsiloxane-co-diphenylsiloxane), poly(1,1-diethylpropyl methacrylate), polytriethylcarbinyl methacrylate, poly(2-decyl-1,4-butadiene), polymercaptopropylmethylsiloxane, polyethylglycolate methacrylate, poly(3-methylcyclohexyl methacrylate), poly(cyclohexyl α-ethoxyacrylate), methylcellulose, poly(4-methylcyclohexyl methacrylate), poly(decamethylene glycol dimethacrylate), polyvinyl alcohol, polyvinyl formal, poly(2-bromo-4-trifluoromethyl styrene), poly(1,2-butadiene), poly(sec-butyl α-chloroacrylate), poly(2-heptyl-1,4-butadiene), polyvinyl methyl ketone, polyethyl α-chloroacrylate, poly(2-isopropyl-1,4-butadiene), poly(2-methylcyclohexyl methacrylate), polybornyl methacrylate, poly(2-t-butyl-1,4-butadiene), polyethylene glycol dimethacrylate, polycyclohexyl methacrylate, polycyclohexanediol-1,4-dimethacrylate, butyl rubber, trans-1,4-polyisoprene (Gutta percha), polytetrahydroperfuryl methacrylate, polyisobutylene, low density polyethylene, ethylene/methacrylic acid ionomer, polyethylene, cellulose nitrate, polyethylene ionomer, polyacetal, poly(1-methylcyclohexyl methacrylate), poly(2-hydroxyethyl methacrylate), poly(1-butene), polyvinyl methacrylate, and polyvinyl chloroacetate.

In the present disclosure, a difference in dielectric constant between the optical modulator and the base resin may be 2 or less.

The present disclosure also provides a metamaterial film prepared from the metamaterial composition.

In the present disclosure, the metamaterial film may comprise a base resin film, aerogel particles dispersed in the base resin, and an optical modulator impregnated into the aerogel particles.

In the present disclosure, the metamaterial film may have a thickness of 1 μm to 1 mm.

In the present disclosure, the metamaterial film may be used as a cover window for a display.

In the present disclosure, the metamaterial film may further comprise a near-infrared reflective layer formed on one or both sides of the film.

In the present disclosure, the near-infrared reflective layer may comprise one or more selected from the group consisting of silver nanoparticles, silver nanowires, silver nanoaerogels, silver nanodiscs, silver nanoparticles with a core-shell structure, and silver nanowires with a core-shell structure.

The present disclosure also provides a method for preparing the metamaterial film.

In the present disclosure, a method of preparing the metamaterial film may comprise: mixing aerogel particles and an optical modulator to impregnate the aerogel particles with the optical modulator: mixing the aerogel particles impregnated with the optical modulator in a base resin; and coating the mixture onto a substrate to prepare the film.

### Advantageous Effects

In the present disclosure, the aerogel particles impregnated with the optical modulator are applied to a base resin to prepare a metamaterial, which may significantly improve the emissivity in the atmospheric window region without impairing the transmission of visible light. Therefore, when the metamaterial of the present disclosure is prepared in the form of a film, it may realize excellent transparency and radiative cooling performance even with a thin thickness, and may be usefully used as a radiative cooling film in the form of a display cover window. In addition, the metamaterial of the present disclosure may improve the tensile strength by adjusting the material and does not affect an electrostatic capacitance method, and therefore may be used in flexible displays and touch screens.

### DESCRIPTION OF DRAWINGS

FIG. 1 is a schematic diagram to illustrate light modulating properties of a metamaterial film according to one embodiment of the present disclosure.

FIG. 2 is a schematic diagram to illustrate diffuse transmission of a metamaterial film according to one embodiment of the present disclosure.

FIG. 3 is a schematic diagram to illustrate the properties of preventing water vapor transmission of a metamaterial film according to one embodiment of the present disclosure.

FIG. 4 is a process diagram of a method for preparing a metamaterial according to one embodiment of the present disclosure.

FIG. 5 schematically illustrates a laminate using a near-infrared reflective metamaterial film according to one embodiment of the present disclosure.

FIG. 6 schematically illustrates a form in which a metamaterial film according to one embodiment of the present disclosure is applied as a display cover window.

FIG. 7 schematically illustrates a form in which a metamaterial film according to one embodiment of the present disclosure is applied as a radiative cooling film of light emitting diode.

FIG. 8 is a graph illustrating the results of measuring emissivity depending on the amount and thickness of aerogel particles added for a metamaterial film according to one embodiment of the present disclosure.

FIG. 9 is a graph illustrating the results of measuring visible light transmittance and a haze factor depending on the amount and thickness of aerogel particles added for a metamaterial film according to one embodiment of the present disclosure.

FIG. 10 is an experimental photograph illustrating a visible view of a metamaterial film according to one embodiment of the present disclosure.

FIG. 11 is a photograph testing an anti-glare effect of a metamaterial film according to one embodiment of the present disclosure.

FIG. 12 is a graph illustrating light extraction power of a metamaterial film according to one embodiment of the present disclosure compared to a conventional transparent plastic film (PI).

FIG. 13 is a stress-strain curve measured for a metamaterial film according to one embodiment of the present disclosure.

FIG. 14 is a graph of elastic modulus and tensile strength measured for a metamaterial film according to one embodiment of the present disclosure.

FIG. 15 is a photograph of a bendability test for a metamaterial film according to one embodiment of the present disclosure.

FIG. 16 is a graph of water vapor transmission rate measured for a metamaterial film according to one embodiment of the present disclosure.

FIG. 17 illustrates the results of testing a radiative cooling effect under solar light irradiation conditions for a metamaterial film according to one embodiment of the present disclosure.

FIG. 18 illustrates the results of applying a metamaterial film according to one embodiment of the present disclosure to an LED chip under solar light-free conditions and testing the radiative cooling effect

FIG. 19 illustrates the results of applying a metamaterial film according to one embodiment of the present disclosure to a display under solar light-free conditions and testing the radiant cooling effect.

FIG. 20 is a graph illustrating the results of measuring infrared emissivity of a metamaterial film according to one embodiment of the present disclosure.

FIG. 21 is a graph illustrating the results of measuring a visible light transmittance of a metamaterial film according to one embodiment of the present disclosure.

FIG. 22 is a graph illustrating the results of measuring a haze factor of a metamaterial film according to one embodiment of the present disclosure.

FIG. 23 illustrate a photograph of an NIR reflective metamaterial film according to one embodiment of the present disclosure.

FIG. 24 is a graph illustrating the results of measuring a visible light transmittance of the NIR reflective metamaterial film according to one embodiment of the present disclosure.

FIG. 25 is a graph illustrating the results of measuring a near-infrared emissivity of the NIR reflective metamaterial film according to one embodiment of the present disclosure.

### BEST MODE

Specific aspects of the present disclosure will be described in more detail below. Unless otherwise defined, all technical and scientific terms used in the present specification have the same meaning as commonly understood by a person skilled in the art to which the present disclosure belongs. In general, the nomenclature used herein is well known and commonly used in the art.

The present disclosure relates to a metamaterial composition having radiative cooling characteristics and to a metamaterial film prepared by using the same.

Metamaterials refer to a material that may artificially control the interaction of light with matter by periodically arranging artificial structures that are larger than atoms and much smaller than the wavelength of incident light. Metamaterials exhibit properties that control light, waves, and electromagnetic waves in ways that are impossible with natural materials, and may be used in various applications, such as displays, automobiles, and aircraft depending on their material properties.

General heat dissipation materials have a trade-off problem in that the visible light transmittance is degraded as the heat dissipation improves, and the heat dissipation is reduced as the thickness become thinner. On the other hand, the present disclosure can solve this problem by the realization of a metamaterial having high infrared emissivity and excellent visible light transmittance even with a thin thickness.

To realize these properties, the present disclosure provides a metamaterial composition comprising a base resin, aerogel particles, and an optical modulator.

In the present disclosure, the base resin refers to a material that serves as the base of the film, and a conventional light-transmissive polymer resin used in the preparation of films may be used.

Specifically, in the present disclosure, one or more of polyimide (PI), colorless polyimide (CPI), polydimethylsiloxane (PDMS), perfluoropolyether (PFPE), polyurethane (PU), polyethylene (PE), polypropylene (PP), polycarbonate (PC), polystyrene (PS), polyester, polyamide, etc. may be used as the base resin. Among them, polyimide resin exhibits flexibility with low water vapor transmission rate, and in particular, transparent polyimide has very good transparency, and therefore may be preferably used in the preparation of films used as cover windows for displays.

In an exemplary embodiment of the present disclosure, the base resin may be a light-transmissive polymer resin having a refractive index of 1.2 to 1.8, specifically 1.3 to 1.7, for example, 1.4 to 1.6. In the present disclosure, both radiative cooling characteristics and visible light transmittance may be improved by adjusting a difference in refractive index between the base resin and the optical modulator impregnated into the aerogel.

In the present disclosure, the base resin may be comprised in an amount of 60 to 97 wt %, preferably 75 to 95 wt %, based on the total weight of the metamaterial composition.

In the present disclosure, the base resin may be used in liquid form and mixed with aerogel particles and optical modulators.

The aerogel particles are micro-level particle agglomerates formed by agglomeration of primary particles having a particle diameter of 5 to 50 nm, preferably 10 to 30 nm, wherein the particle diameter of the aerogel particles may be 0.1 to 100 μm, for example, 2 to 25 μm.

One or more of silica (SiO₂) aerogels, titania (TiO₂) aerogels, carbon aerogels, graphene aerogels, etc. may be used as the aerogel particles.

It is desirable to use aerogel particles having a dielectric constant similar to that of the base resin, as the prepared metamaterial film may be applied to a capacitive touch screen. From this point of view, the difference in dielectric constant between the base polymer resin and the aerogel particles is preferably 2 or less. For example, when a polyimide-based resin is used as the base polymer resin, silica aerogels may be preferably used.

The aerogel particles may be comprised in an amount of 1 to 10 wt %, preferably 2 to 6 wt %, and more preferably 3 to 5 wt %, based on the total weight of the metamaterial composition. If the content of the aerogel particles is too low, the emissivity may be insufficient. If the content of the aerogel particles is too high, visible light transmittance may be reduced, and tensile strength and bendability may be reduced.

In an embodiment of the present disclosure, it was confirmed that if the aerogel particles are comprised in an amount of about 4 wt %, visible light transmittance, infrared emissivity, and haze factor are all excellent, tensile strength is high, and bendability is excellent, and that if the content of the aerogel particles is too high, the tensile strength is reduced and the elongation at break is greatly reduced.

When the aerogel particles are applied to the base resin to impart infrared radiation properties, there is a problem that the aerogel particles reduce visible light transmission. In the present disclosure, these problems may be solved through the introduction of an optical modulator, thereby providing a metamaterial with high infrared emissivity and excellent visible light transmittance.

The nanopore air layer of the aerogel particles causes reflection due to scattering. When the nanopores of aerogel particles are impregnated with an optical modifier having a refractive index similar to that of the base resin according to the present disclosure, reflection may be suppressed, thereby preventing a decrease in visible light transmittance caused by the aerogel particles.

In particular, according to the present disclosure, it is possible to use aerogel particles in small amounts to prepare a metamaterial that is advantageous in terms of visible light transmittance and flexibility, while at the same time, the emissivity enhancement effect caused by the aerogel particles is sufficiently exerted to satisfy all of transparency, radiative cooling characteristics, and mechanical properties.

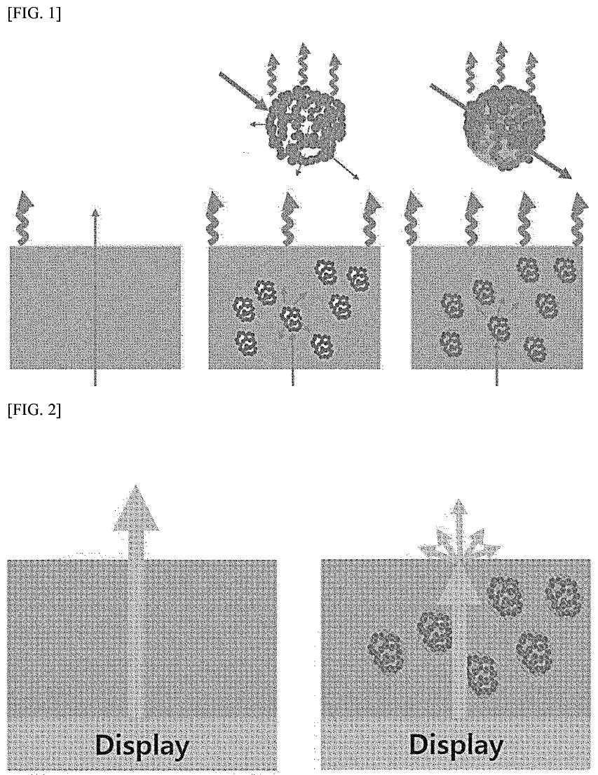

FIG. 1 is a schematic diagram to illustrate the light modulating properties of films prepared with the metamaterials of the present disclosure, compared to a pure base film without the addition of aerogel particles and optical modulators, and a film prepared by adding aerogels to the base resin.

Referring to FIG. 1, a pure base film has high visible light transmittance but low infrared emissivity. Meanwhile, a film containing aerogel has improved infrared emissivity due to the aerogel, but suffers from a problem in that the transmittance is reduced due to scattering reflection of visible light caused by the aerogel particles. However, when an optical modulator is impregnated into aerogel particles according to the present disclosure and applied to a base resin, a heat dissipation effect is maintained while visible light scattering is suppressed, and accordingly, a film having high visible light transmittance and excellent heat dissipation may be prepared.

FIG. 2 is a schematic diagram of the diffusion transmission of a film prepared from the metamaterial of the present disclosure, wherein when the metamaterial film is used, the diffusion transmission of light emitted from the display occurs, so that the transmittance is excellent and the haze is improved, thereby exhibiting an anti-glare effect.

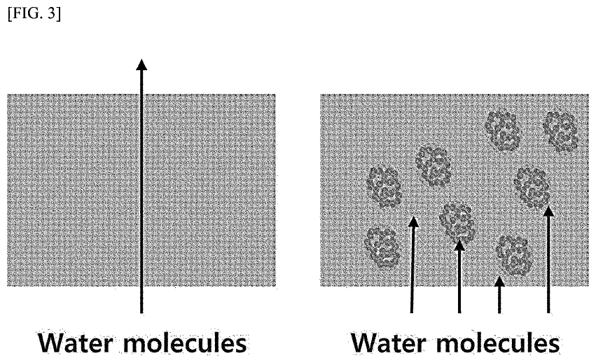

In addition, FIG. 3 is a schematic diagram of a preventing water vapor transmission of a film prepared from the metamaterial of the present disclosure, wherein the water vapor transmission is prevented in the metamaterial film by a complex of aerogel particles and an optical modulator.

The optical modulator used in the present disclosure is an organic compound, and one having a refractive index similar to that of the base resin may be used. Specifically, a material having an absolute value of a difference in refractive index from the base resin of 0.05 or less, preferably 0.03 or less, and more preferably 0.02 or less, may be used as the optical modulator. Accordingly, when an optical modulator is impregnated into an aerogel and applied to the base resin, radiative cooling performance may be improved while suppressing a decrease in transmittance and haze factor in a visible light region.

In the present disclosure, after the optical modulator is impregnated into the nanopores of the aerogel in a liquid state, transparency may be maintained even after conversion to a solid state, as long as the refractive index is similar to that of the base material.

The optical modulator used in the present disclosure is preferable because the lower the viscosity, the easier it is to impregnate into the nano-pores of the aerogel particles. In addition, it is preferable to use materials that do not have too high a surface energy, as large surface energies increase inter-liquid cohesion and make impregnation into the aerogel difficult.

In an exemplary embodiment of the present disclosure, when a polyimide-based resin having a refractive index of about 1.5 is used as the base resin, a material having a refractive index of 1.47 to 1.53 may preferably be used as the optical modulator.

Specific examples of the optical modulator include one or more selected from the group consisting of polymethyl methacrylate (PMMA), diethylenetriamine (DETA), N-methyl-2-pyrrolidone (NMP), polyvinyl methyl ether, poly(3-methoxypropyl acrylate), poly(1-octadecene), poly(2-ethoxyethyl acrylate), polyisopropyl acrylate, poly(1-decene), polypropylene, polylauryl methacrylate, polyvinyl sec-butyl ether, poly(n-butyl acrylate), polydodecyl methacrylate, polyethylene succinate, polytetradecyl methacrylate, polyhexadecyl methacrylate, cellulose acetate butyrate, cellulose acetate, polyvinyl formate, ethylene/vinyl acetate copolymer-40% vinyl acetate, poly(2-fluoroethyl methacrylate), polyoctyl methyl silane, ethylcellulose, polymethyl acrylate, polydicyanopropyl siloxane, polyoxymethylene, poly(sec-butyl methacrylate), poly(dimethylsiloxane-co-α-methyl styrene), poly(n-hexyl methacrylate), ethylene/vinyl acetate copolymer-33% vinyl acetate, poly(n-butyl methacrylate), poly(ethylidene dimethacrylate), poly(2-ethoxyethyl methacrylate), poly(n-propyl methacrylate), polyethylene malate, ethylene/vinyl acetate copolymer-28% vinyl acetate, polyethyl methacrylate, polyvinyl butyral, poly(3,3,5-trimethylcyclohexyl methacrylate), poly(2-nitro-2-methylpropyl methacrylate), poly(dimethylsiloxane-co-diphenylsiloxane), poly(1,1-diethylpropyl methacrylate), polytriethylcarbinyl methacrylate, poly(2-decyl-1,4-butadiene), polymercaptopropylmethylsiloxane, polyethylglycolate methacrylate, poly(3-methylcyclohexyl methacrylate), poly(cyclohexyl α-ethoxyacrylate), methylcellulose, poly(4-methylcyclohexyl methacrylate), poly(decamethylene glycol dimethacrylate), polyvinyl alcohol, polyvinyl formal, poly(2-bromo-4-trifluoromethyl styrene), poly(1,2-butadiene), poly(sec-butyl α-chloroacrylate), poly(2-heptyl-1,4-butadiene), polyvinyl methyl ketone, polyethyl α-chloroacrylate, poly(2-isopropyl-1,4-butadiene), poly(2-methylcyclohexyl methacrylate), polybornyl methacrylate, poly(2-t-butyl-1,4-butadiene), polyethylene glycol dimethacrylate, polycyclohexyl methacrylate, polycyclohexanediol-1,4-dimethacrylate, butyl rubber, trans-1,4-polyisoprene (Gutta percha), polytetrahydroperfuryl methacrylate, polyisobutylene, low density polyethylene, ethylene/methacrylic acid ionomer, polyethylene, cellulose nitrate, polyethylene ionomer, polyacetal, poly(1-methylcyclohexyl methacrylate), poly(2-hydroxyethyl methacrylate), poly(1-butene), polyvinyl methacrylate, and polyvinyl chloroacetate etc., and one or more among them may be used.

Further, for application to a touch screen, it is preferable to use an optical modulator having a difference in dielectric constant of 2 or less from the base resin.

Preferably, when polymethyl methacrylate is used as the optical modulator, it may be stably impregnated into the aerogel particles during the film preparation process. In particular when the base resin is a polyimide-based resin, the use of polymethyl methacrylate as an optical modulator enables the preparation of a film that not only has excellent optical modulation properties, but also may be used for touch screens because it has a small refractive index difference and dielectric constant difference from the base resin.

The optical modulator may be comprised in an amount of 2 to 30 wt %, preferably from 2 to 20 wt %, based on the total weight of the metamaterial composition.

Further, the aerogel particles and optical modulator may be used in a weight ratio of 1:4 to 1:10, preferably 1:6 to 1:9. If the ratio of the optical modulator to the aerogel particles is too low, the visible light transmittance effect by the optical modulator impregnation is insignificant. If the ratio of the optical modulator is too high, the physical or optical properties of the film may be degraded due to excessive optical modulators that are not impregnated into the aerogel.

In the present disclosure, a weight ratio of the mixture of the aerogel particles and the optical modulator and the base resin may be 1:2 to 1:32, preferably 1:2 to 1:10, and the emissivity and transmittance effects by the aerogel particles and the optical modulator may be fully exerted in the above range. In this respect, a weight ratio of the mixture and the base resin is preferably 1:3 to 1:5, and most preferably 1:4.

In addition, the metamaterial compositions of the present disclosure may be mixed with a curing agent as an additive for preparing the mixture in the form of film. As the curing agent, known curing agents such as a heat curing agent and photocuring agents may be used depending on the type of the base resin.

According to the present disclosure, the optical modulator is impregnated into the aerogel particles to form a complex, and this aerogel-optical modulator complex is applied to the base resin to improve a radiation effect by the aerogel particles while suppressing visible light scattering reflection.

Accordingly, the metamaterial film of the present disclosure may have an emissivity of 80% or more, specifically 80 to 99%, and preferably 85 to 99% in the atmosphere window region (wavelength 8 to 13 μm), and a transmittance of 80% or more, specifically 80 to 99%, and preferably 85 to 99%, in the visible light region (wavelength 400 to 800 nm). In addition, the haze factor may be 0.1 to 1.0, preferably 0.2 to 0.9, and more preferably 0.3 to 0.8.

Therefore, the metamaterial of the present disclosure exhibits excellent emissivity and visible light transmittance even with a thin thickness, so they may be useful as a transparent radiative cooling material, and the haze factor may be modulated to exhibit anti-glare effect. In addition, the metamaterial of the present disclosure has excellent mechanical properties, bendability, and low water vapor transmission rate, so films prepared by using it may be used as cover windows for various types of displays.

Accordingly, the present disclosure may also provide a metamaterial film prepared by using the metamaterial composition.

A metamaterial film prepared with a metamaterial composition of the present disclosure may have a structure comprising a base resin, aerogel particles dispersed in the base resin, and an optical modulator impregnated into the aerogel particles. Specifically, the optical modulator may form a complex structure impregnated into the nanopores of the aerogel particles.

The metamaterial film may be prepared by mixing a base resin, aerogel particles and an optical modulator in a liquid phase and forming a film. In this case, the metamaterial film may be prepared by known film preparation techniques, such as coating, molding, pressing, 3D printing, etc.

Specifically, the metamaterial film may be prepared by coating the metamaterial composition on one or both sides of a substrate, wherein known coating methods capable of uniformly applying a coating solution, such as spin coating, spray coating, blade coating, and dip coating, etc., may be used as the coating method.

As such, a metamaterial in the form of a film may be obtained by forming a metamaterial coating and then curing it. In the present disclosure, a curing temperature for forming the metamaterial film may be 60° C. to 300° C., and the time may be 30 minutes to 5 hours. Preferably, the curing process may be performed in three steps. Specifically, primary curing may be performed at 60 to 100° C. for 10 to 60 minutes, secondary curing may be performed at 120 to 170° C. for 30 to 90 minutes, and third curing may be performed at 180 to 230° C. for 10 to 60 minutes.

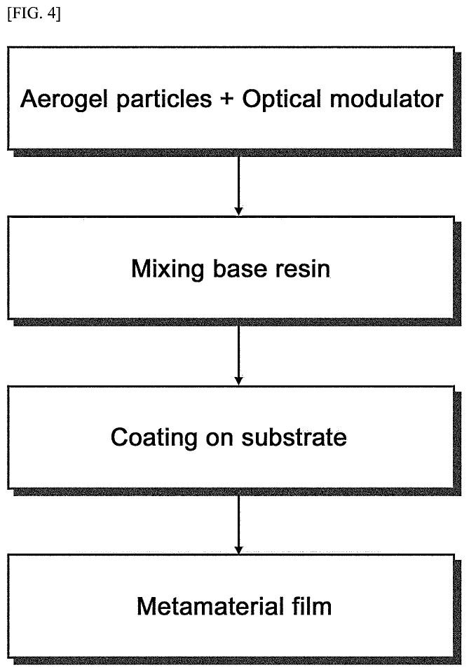

FIG. 4 is a process diagram of a method for preparing a metamaterial according to one embodiment of the present disclosure, illustrating a method of preparing a metamaterial film by mixing aerogel particles and an optical modulator to impregnate the aerogel particles with the optical modulator, then mixing the aerogel particles impregnated with the optical modulator in a base resin and coating the aerogel particles on a substrate.

When a coating method is utilized to prepare a metamaterial film, a metamaterial composition may be coated on a substrate and then cured to prepare a film and separated from the substrate to obtain a film, or a method of directly coating the object to which the film is to be applied may also be used. Here, substrate material capable of withstanding the process of preparing a film, such as glass substrate, plastic substrate, etc., may be used as a substrate.

In addition, the base resin may be mixed with a curing agent as an additive to prepare a film form. The curing agent may be a curing agent such as a thermal curing agent, a light curing agent, etc., depending on the type of base resin.

In the present disclosure, the metamaterial film may have a thickness of 1 μm to 1 mm, preferably 10 to 500 μm, and more preferably 20 to 200 μm. In order to make the display thinner and lighter, it is necessary to manufacture the cover window thinner. In this case, there is a trade-off in that the emissivity is reduced. The present disclosure solves these prior art problems and enables the preparation of a metamaterial film with excellent heat dissipation performance even with a thin thickness through the combination of aerogel particles and optical modulators. In this regard, in one embodiment of the present disclosure, it was confirmed that the emissivity in the atmospheric window region was very good even when the metamaterial was prepared with a thickness of 50 μm.

The metamaterial film of the present disclosure has excellent transparency and improved haze factor, which may prevent glare when applied to a cover window of a display. In addition, when the metamaterial film is applied to a heating element, the radiative cooling characteristics exhibited by the excellent heat dissipation, thereby suppressing a temperature rise of the heating element and improving light extraction efficiency. In addition, the metamaterial film of the present disclosure has excellent mechanical strength and high flexibility, and therefore may be used as a flexible material and may be applied to touch screens.

In one embodiment of the present disclosure, the metamaterial film may be a near-infrared (NIR) reflective metamaterial film, further comprising a NIR reflective layer formed on one or both sides of the film.

The near-infrared reflective layer may comprise one or more metal materials having near-infrared reflective properties, such as silver (Ag), gold (Au), copper (Cu), etc., preferably silver (Ag). Specifically, one or more of silver nanoparticles, silver nanowires, silver nanoaerogels, silver nanodiscs, silver nanoparticles with a core-shell structure, silver nanowires with a core-shell structure, etc. may be used as the metal material.

When a silver material with a core-shell structure is utilized as the metal material, the shell may be made of a material having a refractive index higher than that of silver in the visible light region by 1.5 or more, preferably 2.0 or more. For example, TiO₂, ZnO, etc., may be used as a shell material. Also preferably, a shell material having a lower extinction coefficient than silver may be used as the shell material. If a material that satisfies the above conditions of refractive index and absorption coefficient is used as the material of the shell, it is desirable because the visible light transmittance of the near-infrared reflective layer may be increased.

The near-infrared reflective layer may further comprise a polymer forming a framework of the structure. One or more of poly(ethylene oxide) (PEO), polyvinyl alcohol (PVA), polyethylene glycol (PEG), etc. may be used as the polymer. In addition, the near-infrared reflective layer may exhibit a 2.5 to 3-dimensional structure.

In the near-infrared reflective layer, the polymer and the metal material may be mixed in the weight ratio of 1:0.25 to 1:4, and specifically, the weight ratio is preferably 1:0.25 to 1:1.

In the near-infrared reflective metamaterial film according to the present disclosure, the weight ratio of the near-infrared reflective layer and the metamaterial may be 1:1 to 1:10, more preferably 1:2 to 1:4, more preferably 1:2 to 1:3. In the above range, a film with excellent near-infrared reflection properties and visible light transmittance may be prepared.

The near-infrared reflective metamaterial film exhibits a property of reflecting light in the near-infrared region while transmitting light in the visible region. Thus, this makes it possible to prepare films that radiate infrared light while transmitting visible light from the outside and reflecting near-infrared light, thereby maximizing radiative cooling efficiency.

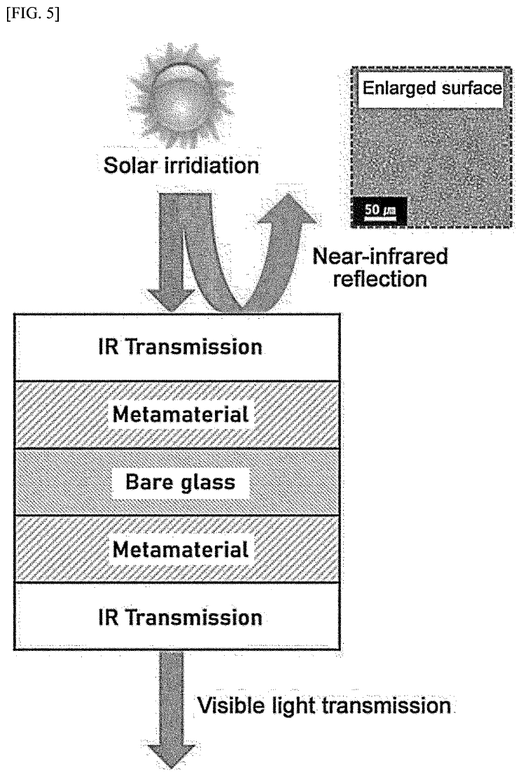

The near-infrared reflective metamaterial film may be used as a film itself or as a coating on a glass substrate, or may be used in the form of laminate with other coatings/films. FIG. 5 schematically illustrates a laminate using a near-infrared reflective metamaterial film of the present disclosure. The laminate comprises a near-infrared reflective metamaterial film formed on both sides of the glass substrate and an infrared transmissive layer formed on one side of each metamaterial film.

As shown in FIG. 5, when the laminate is irradiated with solar light, near-infrared light is reflected and visible light is transmitted. In this case, the high content of silver nanomaterials and aerogel particles in the NIR reflective metamaterial film may promote NIR reflection and MIR emission. On the other hand, if the content of silver nanomaterials is high and the content of aerogel particles is low, near-infrared reflection may be promoted and mid-infrared radiation may be suppressed.

As such, using the present disclosure, a film with near-infrared reflective properties may be prepared in a simple manner, and may exhibit excellent properties even as laminates with a small number of layers.

The metamaterial film of the present disclosure may be used in a variety of applications requiring good transparency and radiative cooling characteristics, and may be typically used as a cover window for a display, a radiation cooling film for LEDs, etc.

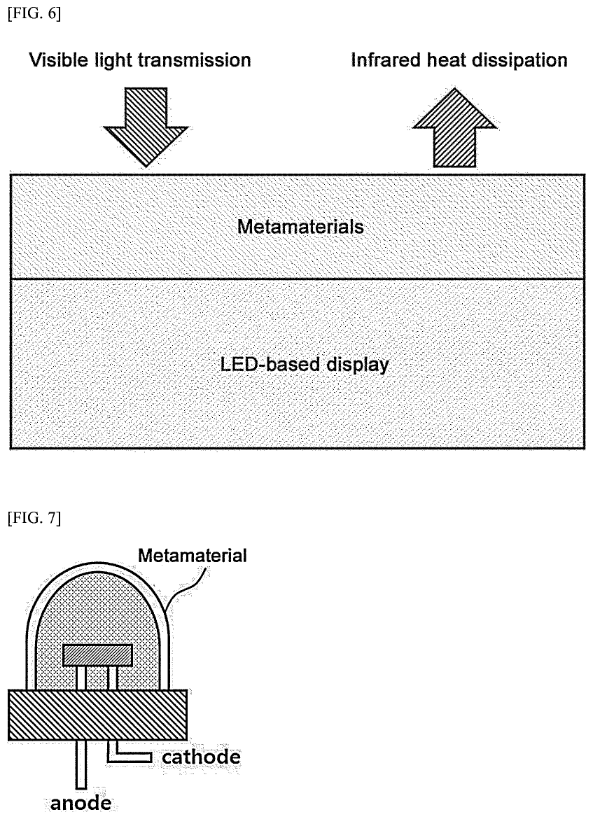

FIGS. 6 and 7 schematically illustrate the metamaterial film of the present disclosure used as a display cover window and applied to a light emitting diode, respectively. As shown in FIGS. 6 and 7, the metamaterial film of the present disclosure may be used to suppress the temperature rise of the heating element while exhibiting anti-glare effects.

### EXAMPLES

Hereinafter the present disclosure will be described in more detail through Examples. However, these Examples show some experimental methods and compositions to illustratively illustrate the present disclosure, and the scope of the present disclosure is not limited to these Examples.

### Preparation Example: Preparation of Film Using Metamaterial Compositions

Metamaterial films were prepared by using polyimide (PI) as a base resin, SiO₂ aerogel particles (SAP) as aerogel particles, and polymethyl methacrylate (PMMA) as an optical modulator.

The aerogel particles and the optical modulator were mixed at a weight ratio of 1:8, and the mixture was mixed with the base resin. At this time, the mixture of aerogel particles and optical modulator, and the base resin were mixed at a weight ratio of 1:4. The substrate was thinly coated by spin coating, and then a three-step curing process was performed by sequentially varying the temperature and time conditions to 80° C. for 30 minutes, 150° C. for 1 hour, and 200° C. for 30 minutes. After curing was completed, the metamaterial film was separated to obtain a free-standing film with a thickness of 50 μm.

### Experimental Example 1: Emissivity Measurement in Atmospheric Window Region of Metamaterial Film

Metamaterial films were prepared by using the methods of the Preparation Examples, but with adjustments to the amount of aerogel particles and the film thickness, and the emissivity was measured.

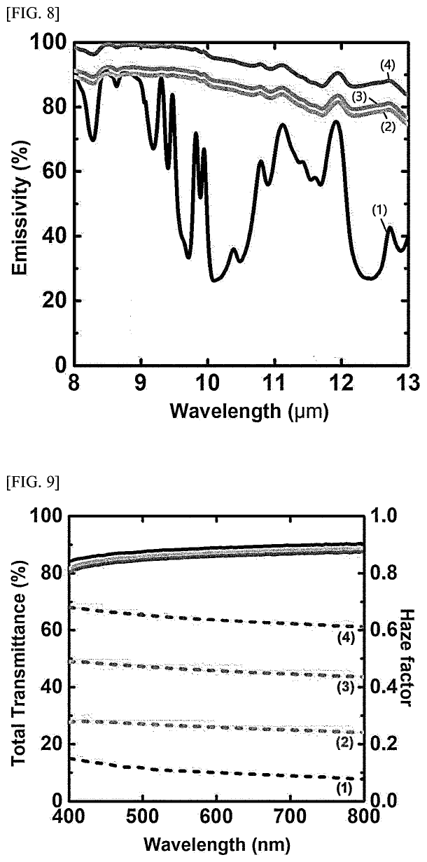

The amount (wt %) of aerogel particles added and thickness (μm) for each film, and the emissivity (%) measurement results in each wavelength range, are shown in FIG. 8 and Table 1 below.

TABLE 1

| | | | Emissivity | Emissivity |
|---|---|---|---|---|
| Number | Aerogel content | Thickness | (2.5~25 μm) | (8~13 μm) |
| (1) | 0 | 50 | 46.3 | 62.2 |
| (2) | 1 | 50 | 80.2 | 85.6 |
| (3) | 1 | 200 | 81.8 | 87.6 |
| (4) | 4 | 50 | 89.1 | 94.7 |

Referring to the above experimental results, it is confirmed that the film prepared by using the metamaterial according to the present disclosure has a high emissivity even when the thickness is as thin as 50 μm, and it is possible to achieve up to about 95% in the wavelength range of 8 to 13 μm, which is the atmospheric window region. These results confirmed that the radiative cooling characteristics of metamaterial films were excellent.

### Experimental Example 2: Measurement of Transmittance and Haze Factor of Metamaterial Film

For the same films as in Experimental Example 1, the visible light transmittance (Tₜₒₜₐₗ, %) and haze factor of each film were measured, and the results were shown in Table 2 below, and the resulting graph is shown in FIG. 9.

TABLE 2

| | | | Total | |
|---|---|---|---|---|
| Number | Aerogel content | Thickness | transmittance | Haze factor |
| (1) | 0 | 50 | 88.4 | 0.10 |
| (2) | 1 | 50 | 86.8 | 0.26 |
| (3) | 1 | 200 | 86.1 | 0.45 |
| (4) | 4 | 50 | 85.5 | 0.64 |

Referring to the above results, the film prepared by using the metamaterial according to the present disclosure has a transmittance of 85.5% in the visible light region (400 to 800 nm), showing a transmittance of about 96.7% compared to existing transparent plastic (PI). Accordingly, it was confirmed that the metamaterial film of the present disclosure had excellent transparency.

In addition, the metamaterial film of the present disclosure showed an increase in haze factor of up to 0.54 compared to conventional transparent plastic (PI). This increase in haze factor is related to the film's anti-glare effectiveness and light extraction power.

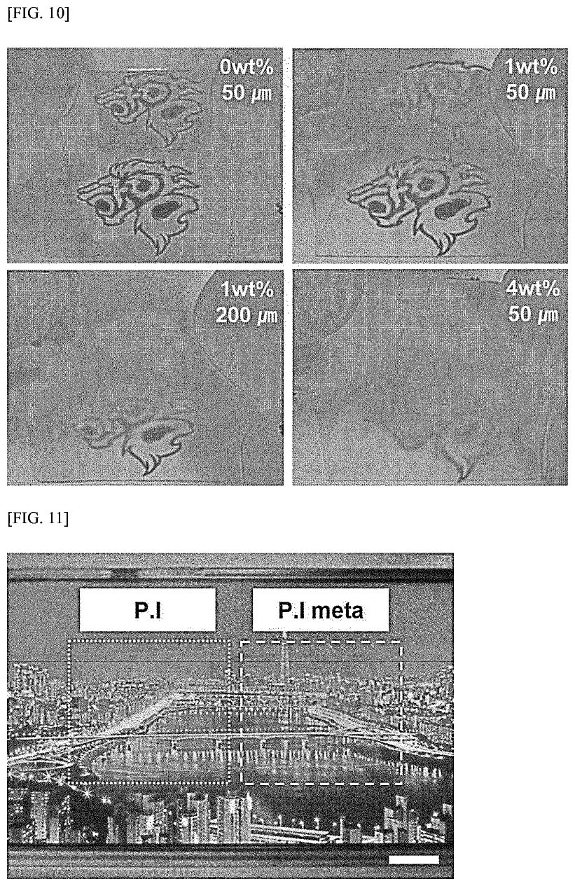

FIG. 10 is an experimental photograph illustrating the visible appearance of each film. FIG. 11 is a photograph testing the anti-glare effectiveness of conventional transparent plastic (PI) and metamaterial films. Referring to the above experimental results, it can be confirmed that the metamaterial film according to the present disclosure exhibits excellent transparency, improved haze factor, and a pronounced anti-glare effect.

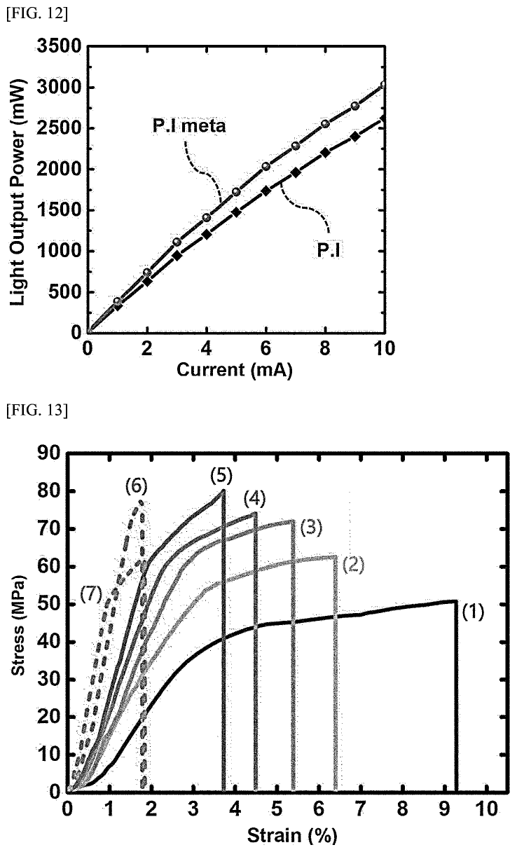

This improvement in haze factor also affects the light extraction power. FIG. 12 is a graph illustrating the light extraction power of the metamaterial film compared to a conventional transparent plastic film (PI). As a result of the experiment, it was confirmed that the light extraction power of the metamaterial film of the present disclosure increased by up to 16% compared to the conventional transparent plastic.

Accordingly, it was confirmed that the metamaterial film of the present disclosure has an excellent anti-glare effect and may improve the light extraction efficiency by improving the haze factor.

### Experimental Example 3: Measurement of Change in Mechanical Strength of Metamaterial Film According to Addition of Aerogel Particles

For the metamaterial film, the change in mechanical strength according to the addition and content of aerogel was measured.

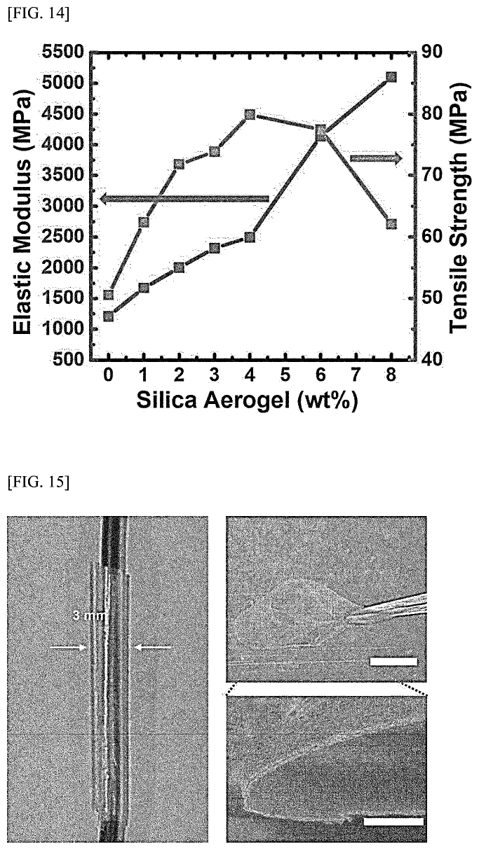

By a method of Preparation Example, a metamaterial film with a thickness of 50 μm was prepared by adjusting the aerogel content to 0, 1, 2, 3, 4, 6, and 8 wt %, and a stress-strain curve obtained by performing a tensile test on the film is shown in FIG. 13, and a graph of the elastic modulus (GPa) and tensile strength (MPa) calculated therefrom is shown in FIG. 14. The elastic modulus, tensile strength, and elongation at break (%) values obtained from the above experiments are shown in Table 3 below.

TABLE 3

| | | Elastic | Tensile | Elongation at |
|---|---|---|---|---|
| Number | Materials | modulus | strength | break |
| (1) | bare PI | 1.2 | 50.6 | 9.30 |
| (2) | PI meta (SAP 1 wt %) | 1.7 | 62.4 | 6.41 |
| (3) | PI meta (SAP 2 wt %) | 2.0 | 71.8 | 5.40 |
| (4) | PI meta (SAP 3 wt %) | 2.3 | 73.9 | 4.49 |
| (5) | PI meta (SAP 4 wt %) | 2.5 | 79.9 | 3.74 |
| (6) | PI meta (SAP 6 wt %) | 4.2 | 77.5 | 1.78 |
| (7) | PI meta (SAP 8 wt %) | 5.2 | 61.9 | 1.57 |

Referring to the experimental results, the elastic modulus and tensile strength tended to increase with the addition of aerogel. The addition of 4 wt % of aerogel increased the elastic modulus by about 280% and the tensile strength by about 58% compared to bare PI. However, it was confirmed that when the aerogel content was 6 wt %, the tensile strength began to decrease, and when the added amount was 8 wt %, the value decreased significantly. This is due to the weakening of the interfacial interaction between polyimide resin and aerogel by aerogel agglomeration. According to the above experimental results, it could be confirmed that the best mechanical strength was observed when the amount of aerogel particles added was around 4 wt %.

FIG. 15 illustrates a photograph of the bendability test results for a metamaterial film of Preparation Example of the present disclosure. It could be confirmed that the addition of aerogels to improve strength typically results in a decrease in bendability, but the metamaterial film of the present disclosure maintains excellent bendability even with the addition of aerogels.

Thus, it could be confirmed that the metamaterial film of the present disclosure can also be useful used for cover windows that require both mechanical strength and bendability.

### Experimental Example 4: Measurement of Water Vapor Transmission Rate of Metamaterial Film

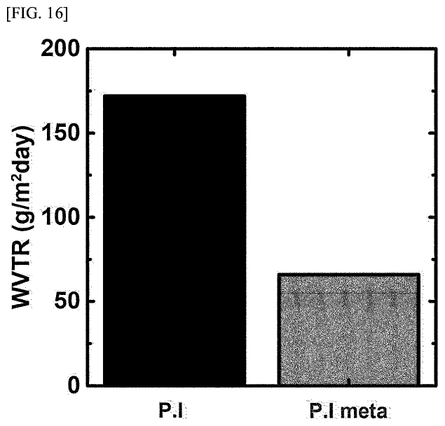

Water vapor was transmitted through the metamaterial film of the Preparation Example and moved to the sensor by a carrier gas (N₂) in a chamber to measure the water vapor transmission rate (WVTR), and the results are shown in FIG. 16.

The experimental results showed that the water vapor transmission rate of the metamaterial film of the present disclosure has improved by the combined structure of aerogel (SiO₂) and optical modulator (PMMA), resulting in the water vapor transmission rate of 66 g/m²·day, which is about 62% lower than the water vapor transmission rate of 172 g/m²·day of conventional PI.

Thus, it was found that the metamaterial film of the present disclosure may be usefully applied in applications where a barrier performance to prevent the water vapor transmission rate is required, particularly in cover windows of displays.

### Experimental Example 5: Measurement of Cooling Effect of Metamaterial Film

The metamaterial film of the Preparation Example was applied to a heating element, and the cooling effect was tested by comparing the temperature with that of the case where a general PI film was applied.

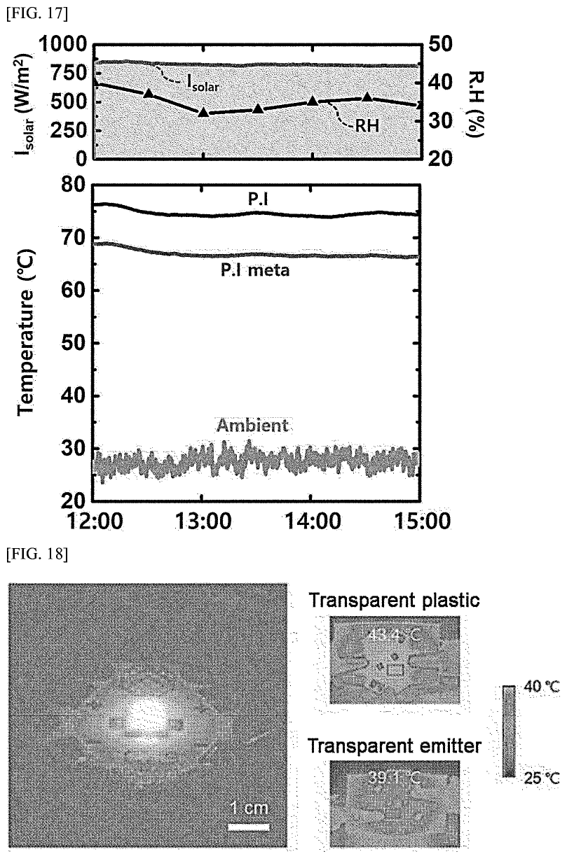

Specifically, the metamaterial film and the PI film were each applied to a display simulation heater in an outdoor environment in Seoul (˜900 W/m²) in September, and solar intensity (Iₛₒₗₐᵣ)/humidity (RH) conditions and temperature changes are shown in FIG. 17. Referring to the results in FIG. 17, it can be confirmed that the self-heating material has a cooling effect of about 8° C. under solar irradiation circumstance.

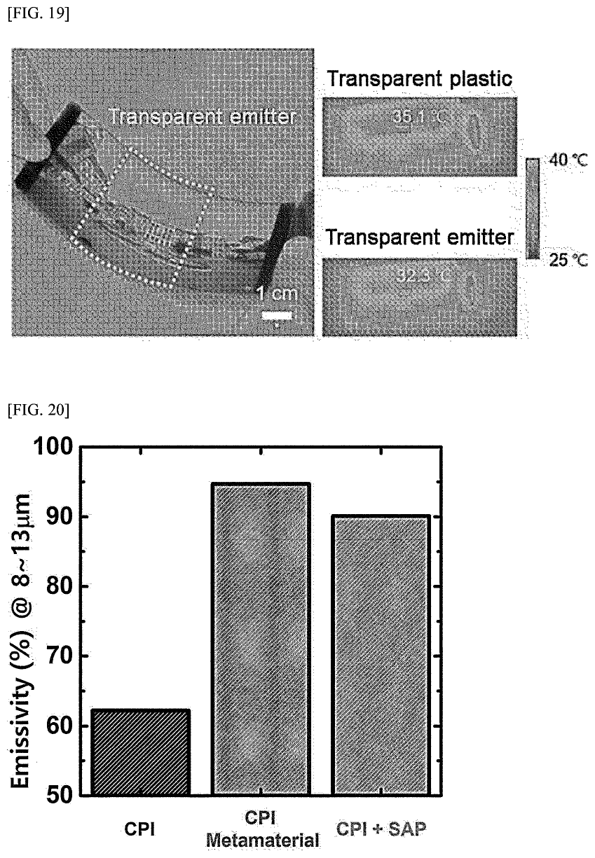

In addition, transparent plastic (PI) and metamaterial emitter films were applied to actual LED chips and displays in the absence of solar irradiation, and the results of confirming the temperature difference by photographing with a thermal imaging camera shown in FIGS. 18 and 19, respectively. As a result of the experiment, it was confirmed that when the metamaterial film was applied, the maximum temperature for LED was about 4° C. lower than that of the PI film, and that the maximum temperature for the display was about 3° C. lower than that of the PI film. Thus, it could be confirmed that the metamaterial film of the present disclosure has a cooling effect on actual LEDs and displays in the absence of solar irradiation.

### Experimental Example 6: Analysis of Optical Characteristics of Metamaterial Film

Using the method of the Preparation Example, a colorless polyimide (CPI) as the base resin was used to prepare a metamaterial film (CPI metamaterial). The optical properties of the prepared metamaterial film were evaluated by measuring the emissivity (%) at 8 to 13 μm, the total transmittance (%) in the visible region, and the haze factor in the visible region. For comparison, the same tests were performed on CPI films without the addition of aerogel and optical modulator and on CPI+SAP films with the addition of aerogel only.

FIGS. 20, 21, and 22 are graphs illustrating the measurement results of emissivity, transmittance, and haze factor for the films. Referring to the measurement results in FIG. 20, it can be confirmed that the CPI film has an emissivity of about 65%, while the metamaterial film has a high emissivity of about 95%. Comparing the results with CPI+SAP films, it was found that the addition of aerogels alone did not result in a high emissivity of about 95%, and that the emissivity was further improved by the combined use of aerogels and optical modulators.

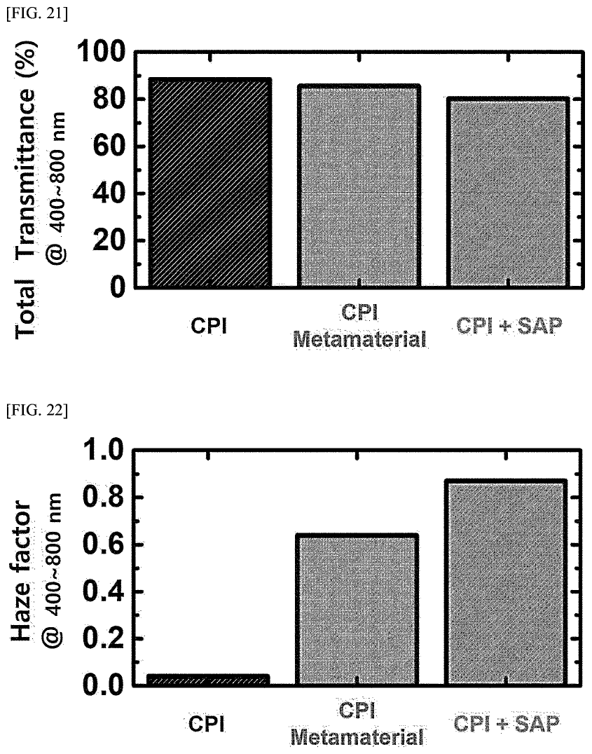

Furthermore, referring to the results in FIG. 21, it can be confirmed that the addition of SAP to CPI results in a significant (about 10%) reduction in visible light transmittance compared to the base CPI, whereas a film prepared from metamaterials with SAP and optical modulators show almost no reduction in transmittance. Thus, it was found that the use of an optical modulator with the aerogel could prevent the decrease in transmittance caused by the aerogel.

Referring to the results in FIG. 22, the CPI film had a very low haze factor of about 0.1, while the film with SAP added to CPI had a very high haze factor of about 0.9. However, it was confirmed that the metamaterial film of the present disclosure using a combination of SAP and an optical modulator has a haze factor of about 0.65, which is a level that may prevent glare and improve light extraction efficiency while having a high transmittance.

Taking the above results together, it can be confirmed that the metamaterial film prepared by adding aerogel and optical modulator together to the base CPI according to the present disclosure has a transmittance similar to the base CPI film, a very excellent emissivity, and a higher haze factor, and can exhibit anti-glare effect, while the film with SAP only has a significantly lower transmittance, an excessively high haze level, and a lower emissivity than the metamaterial film.

Thus, it could be confirmed that the metamaterials of the present disclosure exhibit a synergistic effect in terms of optical properties through the combined use of aerogel and optical modulator, making it possible to prepare films with excellent performance in terms of emissivity, transmittance, and haze factor.

### Experimental Example 7: Preparation and Optical Characteristics Measurement of Near-Infrared Reflective Metamaterial Film

A near-infrared (NIR) reflective metamaterial film was prepared by using the metamaterials used in the Preparation Examples, and the total transmittance (Tₜₒₜₐₗ, %) in the visible region (400 to 800 nm) and total reflectance (Rₜₒₜₐₗ, %) in the near-infrared region (800 to 2,500 nm) were measured.

Specifically, a NIR reflective metamaterial film was prepared by coating a silver nanoparticle-based near-infrared reflective layer on a substrate and coating a transparent metamaterial on it.

To prepare the near-infrared reflective layer, poly(ethylene oxide) (PEO) and Ag were mixed in a weight ratio of 1:0.25, spin-coated on a substrate, and freeze-dried at 80° C. for 30 min to form silver nanostructures. A transparent metamaterial was thinly coated by spin coating on the near-infrared reflective layer, and the weight ratio of the near-infrared reflective layer and the transparent metamaterial was 1:2. After curing at 100° C. for 1 hour, it was separated into a free-standing film to prepare a NIR reflective metamaterial.

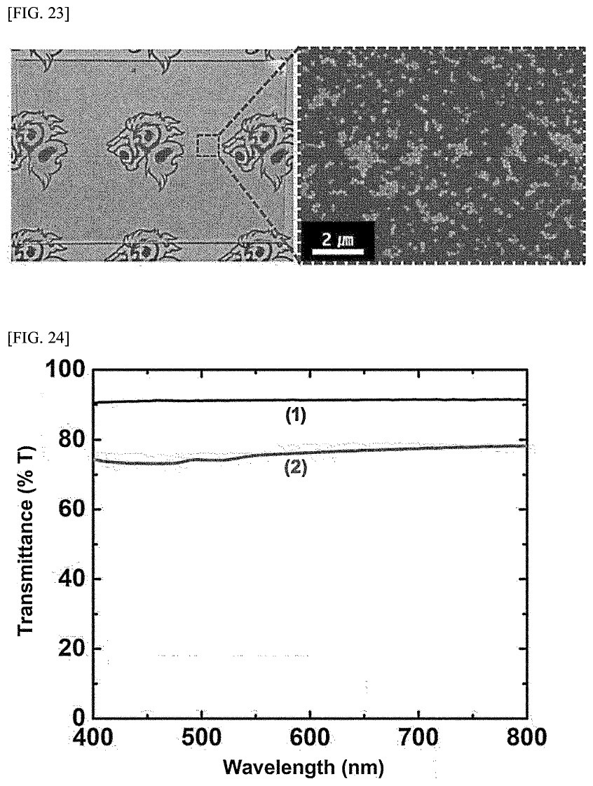

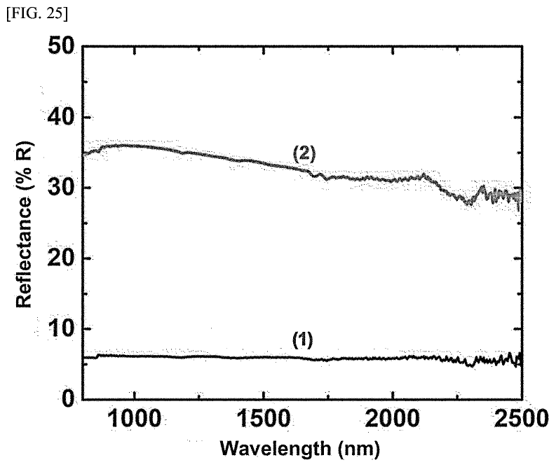

FIG. 23 illustrate a photograph of a prepared NIR reflective metamaterial film. Visible light transmittance and near-infrared reflectance were measured for the film (1) prepared by using only metamaterials and the NIR reflective metamaterial film (2), and the resulting graphs are shown in FIGS. 24 and 25, respectively, and the measured values are shown in Table 4 below.

TABLE 4

| Film | Total transmittance | Total reflectance |
|---|---|---|
| Metamaterial film | 91.3 | 6.01 |
| NIR reflective metamaterial film | 75.8 | 34.4 |

Experiment results showed that coating the metamaterial film with an NIR reflective layer significantly improves near-infrared reflectance to about 35% while transmitting 70% or more of visible light. Therefore, it was confirmed that a NIR reflective film with very excellent optical properties may be prepared by forming an NIR reflective layer on the metamaterial film.

As the specific parts of the present disclosure have been described in detail above, it will be obvious to those skilled in the art that these specific techniques are merely preferred embodiments and do not limit the scope of the present disclosure. Therefore, it will be said that the substantial scope of the present disclosure is defined by the appended claims and their equivalents.

1. A metamaterial composition, comprising a base resin, aerogel particles, and an optical modulator impregnated into the aerogel particles,
wherein the optical modulator is an organic compound having a difference in refractive index of 0.05 or less from the base resin.

2. The metamaterial composition of claim 1,
wherein the base resin has a refractive index of 1.2 to 1.8.

3. The metamaterial composition of claim 1,
wherein the base resin is one or more selected from the group consisting of polyimide (PI), colorless polyimide (CPI), polydimethylsiloxane (PDMS), perfluoropolyether (PFPE), polyurethane (PU), polyethylene (PE), polypropylene (PP), polycarbonate (PC), polystyrene (PS), polyester, and polyamide.

4. The metamaterial composition of claim 1,
wherein the aerogel particles are one or more selected from the group consisting of silica (SiO₂) aerogels, titania (TiO₂) aerogels, carbon aerogels, and graphene aerogels.

5. The metamaterial composition of claim 1,
wherein the aerogel particles are comprised in an amount of 1 to 10 wt %, based on the total weight of the metamaterial composition.

6. The metamaterial composition of claim 1,
wherein a difference in dielectric constant between the aerogel particles and the base resin is 2 or less.

7. The metamaterial composition of claim 1,
wherein the content of the optical modulator is 2 to 30 wt %, based on the total weight of the metamaterial composition.

8. The metamaterial composition of claim 1,
wherein the optical modulator is one or more selected from the group consisting of polymethyl methacrylate (PMMA), diethylenetriamine (DETA), N-methyl-2-pyrrolidone (NMP), polyvinyl methyl ether, poly(3-methoxypropyl acrylate), poly(1-octadecene), poly(2-ethoxyethyl acrylate), polyisopropyl acrylate, poly(1-decene), polypropylene, polylauryl methacrylate, polyvinyl sec-butyl ether, poly(n-butyl acrylate), polydodecyl methacrylate, polyethylene succinate, polytetradecyl methacrylate, polyhexadecyl methacrylate, cellulose acetate butyrate, cellulose acetate, polyvinyl formate, ethylene/vinyl acetate copolymer-40% vinyl acetate, poly(2-fluoroethyl methacrylate), polyoctyl methyl silane, ethylcellulose, polymethyl acrylate, polydicyanopropyl siloxane, polyoxymethylene, poly(sec-butyl methacrylate), poly(dimethylsiloxane-co-α-methyl styrene), poly(n-hexyl methacrylate), ethylene/vinyl acetate copolymer-33% vinyl acetate, poly(n-butyl methacrylate), poly(ethylidene dimethacrylate), poly(2-ethoxyethyl methacrylate), poly(n-propyl methacrylate), polyethylene malate, ethylene/vinyl acetate copolymer-28% vinyl acetate, polyethyl methacrylate, polyvinyl butyral, poly(3,3,5-trimethylcyclohexyl methacrylate), poly(2-nitro-2-methylpropyl methacrylate), poly(dimethylsiloxane-co-diphenylsiloxane), poly(1,1-diethylpropyl methacrylate), polytriethylcarbinyl methacrylate, poly(2-decyl-1,4-butadiene), polymercaptopropylmethylsiloxane, polyethylglycolate methacrylate, poly(3-methylcyclohexyl methacrylate), poly(cyclohexyl α-ethoxyacrylate), methylcellulose, poly(4-methylcyclohexyl methacrylate), poly(decamethylene glycol dimethacrylate), polyvinyl alcohol, polyvinyl Formal, poly(2-bromo-4-trifluoromethyl styrene), poly(1,2-butadiene), poly(sec-butyl α-chloroacrylate), poly(2-heptyl-1,4-butadiene), polyvinyl methyl ketone, polyethyl α-chloroacrylate, poly(2-isopropyl-1,4-butadiene), poly(2-methylcyclohexyl methacrylate), polybornyl methacrylate, poly(2-t-butyl-1,4-butadiene), polyethylene glycol dimethacrylate, polycyclohexyl methacrylate, polycyclohexanediol-1,4-dimethacrylate, butyl rubber, trans-1,4-polyisoprene (Gutta percha), polytetrahydroperfuryl methacrylate, polyisobutylene, low density polyethylene, ethylene/methacrylic acid ionomer, polyethylene, cellulose nitrate, polyethylene ionomer, polyacetal, poly(1-methylcyclohexyl methacrylate), poly(2-hydroxyethyl methacrylate), poly(1-butene), polyvinyl methacrylate, and polyvinyl chloroacetate.

9. The metamaterial composition of claim 1,
wherein a difference in the dielectric constants between the optical modulator and the base resin is 2 or less.

10. A metamaterial film, comprising a base resin film, aerogel particles dispersed in the base resin, and an optical modulator impregnated into the aerogel particles,
wherein the optical modulator is an organic compound having a difference in refractive index of 0.05 or less from the base resin.

11. The metamaterial film of claim 10,
wherein the metamaterial film has a thickness of 1 μm to 1 mm.

12. The metamaterial film of claim 10,
wherein the metamaterial film is a cover window for a display.

13. The metamaterial film of claim 10,
further comprising a near-infrared reflective layer formed on one or both sides of the metamaterial film.

14. The metamaterial film of claim 13,
wherein the near-infrared reflective layer comprises one or more selected from the group consisting of silver nanoparticles, silver nanowires, silver nanoaerogels, silver nanodiscs, silver nanoparticles with a core-shell structure, and silver nanowires with a core-shell structure.

15. A method for preparing a metamaterial film, comprising:
mixing aerogel particles and an optical modulator to impregnate the aerogel particles with the optical modulator,
mixing a base resin with the aerogel particles impregnated with the optical modulator, and
coating the mixture onto a substrate to prepare a film,
wherein, the optical modulator is an organic compound having a difference in refractive index of 0.05 or less from the base resin.
